(19) United States
(12) Patent Application Publication
(10) Pub. No.: US 2006/0261803 A1
(43) Pub. Date: Nov. 23, 2006

(54) Cassette seal assembly

(76) Inventors: Steven E. Faetanini, Sandusky, OH (US); Christopher W. Snavely, Republic, OH (US)

Correspondence Address: DELPHI TECHNOLOGIES, INC., M/C 480-410-202, PO BOX 5052, TROY, MI, 48007, US

(21) Appl. No.: 11/354,724

(22) Filed: Feb. 15, 2006

Related U.S. Application Data
(60) Provisional application No. 60/675,630, filed on Apr. 28, 2005.

(51) Int. Cl. G01B 7/30

(52) U.S. Cl. 324/207.25

(57) ABSTRACT

A cassette seal assembly incorporating an element of a sensor system. The seal assembly includes an annular seal member and an annular shield member abutting the seal member to form a monolithic structure. The seal member has a base portion and at least one resilient portion extending from the base portion to resiliently engage another portion of the seal assembly, thereby forming a seal. The seal member and the shield member define an enclosure for receiving and securing at least a portion of the element of the sensor system therein. A cassette sensor system element assembly is also provided including an annular seal member, an annular shield member abutting the seal member to define an enclosure for receiving and maintaining at least a portion of a sensor system element therein, and a sensor system element having at least a portion thereof secured within the enclosure.

### CROSS-REFERENCE TO RELATED APPLICATIONS

This application claims the benefit of provisional application Ser. No. 60/675,630, filed on Apr. 28, 2005.

### BACKGROUND OF THE INVENTION

The present invention relates to environmental seals for bearings and, more particularly, to a seal assembly for a vehicle wheel bearing which incorporates an element of a wheel speed sensor.

Conventional wheel bearings in automotive vehicles include a non-rotatable section (such as a bearing hub), a rotatable section (such as a bearing spindle) rotatably attached to the non-rotatable section, and wheel studs (also called stud bolts). The non-rotatable section typically is attached to a vehicle suspension system component. The stud bolt is press-fit into a through hole in a flange of the spindle. A vehicle wheel is placed on the stud bolts and secured thereon by wheel nuts (also called lug nuts).

Wheel bearings may also include a wheel speed sensor system for an anti-lock-braking-system (ABS). The ABS wheel speed sensor system generally has a target ring attached to the rotatable section of the vehicle wheel bearing. The target ring may incorporate a magnetic encoder that provides a target for the wheel speed sensor. A sensor, typically mounted to a corner knuckle or other non-rotating portion of the vehicle, converts rotational motion of the target ring into an electrical signal having a frequency proportional to the speed of the wheel. A seal member is positioned between the rotatable and non-rotatable sections of the bearing assembly to prevent debris from reaching the bearing rolling elements.

An exposed magnetic encoder element incorporated into the target ring may attract metallic debris. This debris can cause disturbances in the generated electrical signal that may result in inaccurate wheel speed calculations. Thus, in cases where the target ring includes a magnetic element, a non-magnetic shield member may be attached to the bearing to prevent metallic debris from directly attaching to the face of the magnetic element. As the magnetic element rotates, any debris collected on the surface of the shield is either held stationary on the shield or falls off of the shield, depending on the size and configuration of the debris.

However, in existing designs, the shield is applied to the wheel hub in a separate operation after positioning of the bearing seal and the target ring, thereby increasing the manufacturing cost of the wheel assembly. In addition, inconsistencies in the positioning of the shield on the hub produce corresponding inconsistencies in the size of the air gap between the magnetic encoder and the sensor, adversely affecting operation of the sensor.

### SUMMARY OF THE INVENTION

In accordance with the present invention, a seal assembly incorporating an element of a sensor system is provided. The seal assembly includes an annular seal member and an annular shield member abutting the seal member to form a monolithic structure. The seal member has a base portion and at least one resilient portion extending from the base portion to resiliently engage another portion of the seal assembly, thereby forming a seal. The seal member and the shield member define an enclosure for receiving and securing at least a portion of the element of the sensor system therein. A cassette sensor system element assembly is also provided including an annular seal member, an annular shield member abutting the seal member to define an enclosure for receiving and maintaining at least a portion of a sensor system element therein, and a sensor system element having at least a portion thereof secured within the enclosure.

### BRIEF DESCRIPTION OF THE DRAWINGS

In the drawings illustrating embodiments of the present invention:

FIG. 1 is a cross-sectional side view a bearing assembly incorporating one embodiment of a cassette seal assembly in accordance with the present invention;

FIG. 2 is an enlarged cross-sectional view of a portion of FIG. 1 showing the cassette seal of FIG. 1 and an associated assembly tool;

FIG. 3 is a cross-sectional view showing details of the cassette seal assembly of FIG. 1; and

FIG. 4 is a cross-sectional view of multiple cassette seal assemblies in accordance with the present invention stacked together.

### DETAILED DESCRIPTION

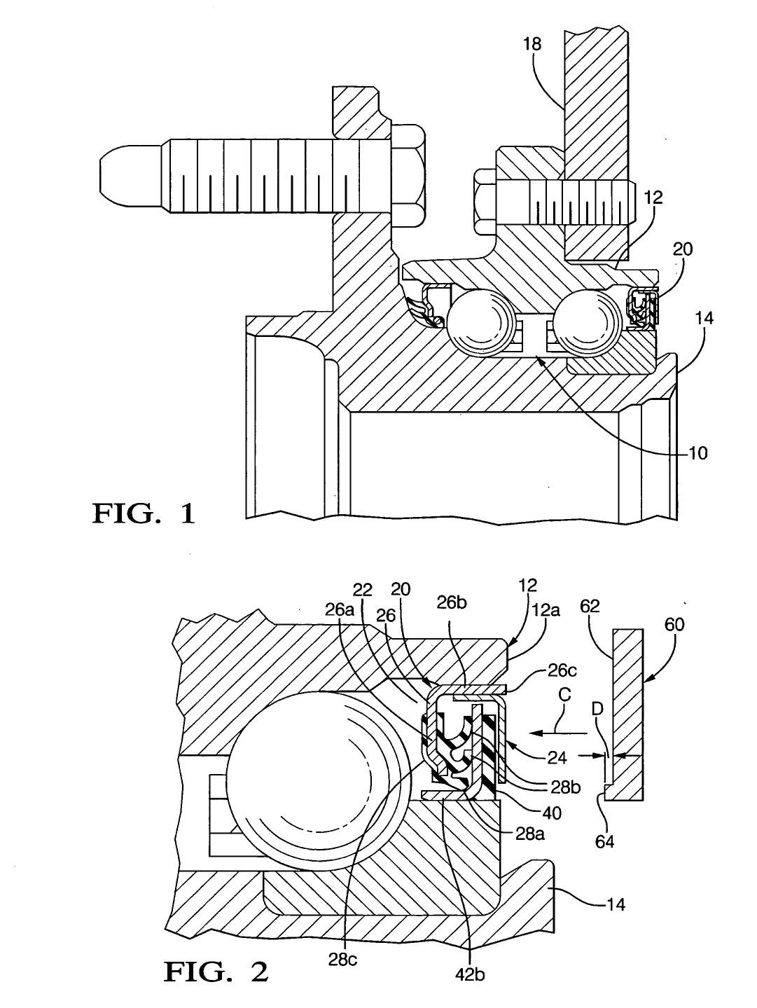

FIGS. 1-4 show a cassette seal assembly, generally designated 20, in accordance with one embodiment of the present invention incorporated into a vehicle wheel roller bearing 10. Referring to FIG. 1, wheel bearing 10 includes a non-rotatable section 12 and a rotatable section 14 rotatably coupled to non-rotatable section 12. In the embodiment shown in FIG. 1, non-rotatable section 12 is a wheel hub and rotatable section 14 is a spindle. A vehicle wheel (not shown) attaches to the spindle. Non-rotatable section 12 of wheel bearing 10 is attached to a vehicle suspension system knuckle 18. Any one of a variety of suitable attachment methods may be used. For example, non-rotatable section 12 may be bolted to knuckle 18, or the non-rotatable section may be press fit to the knuckle. In an alternative embodiment (not shown), the non-rotating member is a spindle and the rotating member is a hub.

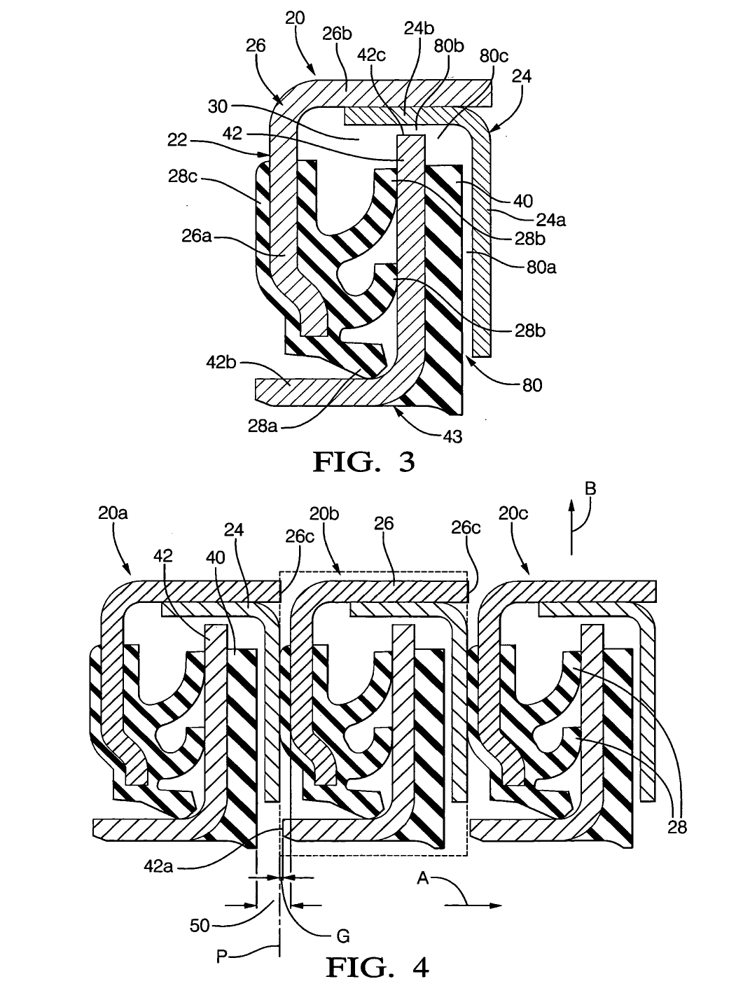

Referring to FIGS. 2-3, cassette seal assembly 20 is located between non-rotatable bearing section 12 and rotatable bearing section 14. Cassette 20 includes an annular seal member 22 and an annular shield member 24 abutting the seal member. Seal member 22 has a base portion 26 including a first wall 26a and a second wall 26b extending from first wall 26a. At least one resilient portion extends from base portion 26. In the embodiment shown in FIGS. 2-3, multiple resilient portions 28a-28c are provided in the form of one radial lip 28a and two axial lips 28b extending from base portion first wall 26a for resiliently engaging other portion(s) of the seal assembly, thereby forming a seal to prevent or obstruct migration of contaminants from an exterior of the seal to the bearing roller elements.

An additional resilient portion, or bump pad, 28c projects from an outer surface 26c of base portion first wall 26a for engaging another, adjacent cassette seal assembly in a manner described in greater detail below. Other lip arrangements and/or other shapes of resilient members are possible. Lips 28a-28c are attached to, or formed on, base portion 26 using any of a variety of known methods, such as adhesive bonding or molding. Lips 28a-28c may be formed from a suitable elastomeric, polymeric, or other material usable for forming a resilient seal. Base portion 26 may be formed from steel or any other suitable metallic or non-metallic material.

As seen in FIGS. 2-3, shield member 24 includes a first wall 24a and a second wall 24b extending from the first wall. Shield member second wall 24b abuts base portion second wall 26b to form a monolithic structure defining an enclosure 30 for receiving at least a portion of an element of the sensor system therein. In the embodiment shown in FIGS. 2-3, shield member second wall 24b forms an interference fit with base portion second wall 26b. In alternative embodiments, (not shown), shield member 24 may be positioned abutting seal member 24 and affixed to seal member 24 using any of a variety of methods (for example, welding or adhesive application.) The purpose of shield member 24 is to prevent metallic debris from directly attaching to the face of a magnetic element (for example, a magnetic encoder) of a sensor system positioned within enclosure 30. As the magnetic element rotates, any debris collected on the surface of shield member 24 is either held stationary on the shield member or falls off, depending on the size and configuration of the debris. Shield member 24 is made of a non-magnetic material, such as stainless steel or plastic.

Referring again to FIG. 3, a sensed element 40 of the wheel speed sensor system is positioned within enclosure 30 and a sensor (not shown) is disposed on a non-rotating portion of the vehicle to detect sensed element 40. In the embodiment shown in FIG. 3, the sensed element 40 comprises a target ring including a magnetic encoder incorporated therein, and the sensor includes a passive sensor element such as a sensor coil disposed to sense rotation of the target ring. The operation of a sensor and a target ring for a vehicle wheel speed sensor, such as an anti-lock-braking-system (ABS) wheel speed sensor, is well known. It should be noted that an active sensor element (such as a Hall Effect, magnetoresistive, optical, or other device) or a passive sensor element can be used, and that a target element other than a magnetic encoder can be used.

In the embodiment shown in FIGS. 1-4, the target ring 40 is attached to an annular slinger 42 to produce a slinger-encoder sub-assembly, generally designated 43. Slinger 42 may be formed from any suitable non-magnetic metallic or non-metallic material. Target ring 40 is formed from a material capable of being substantially permanently magnetized, as known in the art. When a magnetic-encoder type of target element is used, target ring 40 may comprise an elastomeric compound with magnetic particles embedded therein. The elastomer may be molded to an outward face of slinger 42 with alternating north and south magnetic poles formed along the outward face. Alternatively, target ring 40 may be affixed to slinger 42 using other suitable methods, such as adhesive bonding. As another alternative, the target ring can be formed as a relatively rigid one-piece structure for incorporation into seal assembly 20 and attachment to the wheel bearing assembly without the use of a slinger.

As seen in FIGS. 2-3, slinger 42 and target ring 40 are attached to rotatable section 14 of the vehicle wheel bearing 10. Resilient portions 28a-28b extending from base portion 26 engage slinger 42 to form a seal for preventing migration of debris into the rolling elements of the wheel bearing.

Cassette seal assembly 20 is assembled as follows. Referring again to FIG. 3, lips 28a-28b are greased and the slinger-encoder sub-assembly 43 is positioned to engage lips 28a-28b. Shield member second wall 24b is then pressed into engagement with base portion second wall 26b so that an outside surface of shield member wall 24b is flush with an inner surface of base portion second wall 26b, thereby forming an interference fit between walls 24b and 26b, and also forming enclosure 30 for retaining slinger- encoder sub-assembly 43 therein.

Shield member 24 prevents slinger-encoder sub-assembly 43 from exiting enclosure 30 during handling. That is, slinger-encoder sub-assembly 43 can only move until target ring 40 contacts shield member 24. This movement is not enough to allow the cassette assembly to become disassembled. Thus, as seen in FIGS. 3 and 4, the components of the cassette sensor system element assembly are assembled into a monolithic assembly having a cross-section that is substantially rectangular in shape.

FIG. 4 shows multiple cassette seal assemblies 20a-20c stacked together, illustrating several features of the cassette seal assembly that facilitate stacking for shipping and handling during the bearing assembly process. When adjacent cassette seal assemblies 20a and 20b are stacked so as to be in contact with each other, a gap 50 exists between base portion 26 of cassette assembly 20b and magnetic encoder 40 of adjacent cassette assembly 20a. This gap prevents the adjacent cassette assemblies from magnetically adhering to each other while stacked, thus making them relatively easy to separate from each other.

In addition, each cassette assembly 20 has a cross-section that is substantially rectangular in shape. Thus, referring to seal assembly 20a in FIG. 4, an outside surface of shield member 24 aligns with an edge 26c of corresponding seal member base portion 26. Lips 28b projecting from base portion 26 urge magnetic encoder 40 in the direction indicated by arrow A, toward contact with shield member 24. This maintains an end face 42a of slinger 42 flush or slightly spaced apart a distance G from a plane P defined by an outer surface of bump pad 28c. Therefore, as a cross section of the cassette assembly fits within a substantially rectangular envelope, a cassette assembly as described herein can be sliced off the stack (in the direction indicated by arrow B) without any of the cassette features catching or snagging on an adjacent cassette seal assembly.

FIG. 2 illustrates insertion of the cassette seal assembly into the wheel bearing. Cassette seal assembly 20 is assembled into the bearing in a single press operation using a specially designed press tool 60. Press tool 60 has a first planar surface 62 and a projection or step 64 extending from planar surface 62. When press tool 60 is urged in the direction indicated by arrow C, tool surface 62 engages edge 26c of seal member base portion 26 and an outer surface of shield member 24, while step surface 64 engages an outer surface of target ring 40.

The spacing D between surface 62 and step surface 64 establishes the clearance between the outer surface of target ring 40 and shield member 24. As tool 60 forces the cassette seal assembly into the bearing, an exterior surface of base portion second wall 26b engages an interior surface of hub 12 in an interference fit, and a lower wall 42b of slinger 42 engages surface wheel bearing rotatable portion 14 in an interference fit. Thus, seal member 22 and shield member 24 are engaged with non-rotatable bearing member 12, while slinger 42 and target wheel 40 are engaged with rotatable bearing member 14. Tool surfaces 62 and 64 urge the cassette seal assembly into the bearing until tool surface 62 abuts an end face 12a of bearing non-rotatable section 12, thereby providing controllable, consistent positioning of cassette seal assembly 20 with respect to end face 12a.

Positioning and securing at least a portion of slinger-encoder sub-assembly 43 in enclosure 30 formed by shield member 24 and seal member 22 also provides a cassette sensor system element assembly including the shield member, the seal member, and the portion of slinger-encoder sub-assembly 43 positioned within enclosure 30. Securing slinger-encoder sub-assembly 43 within enclosure 30 enables the slinger-encoder sub-assembly to be relatively easily and simply secured to the wheel bearing using the assembly tool previously described.

Referring again to FIG. 3, it may be seen that seal member 22, shield member 24, and slinger-encoder sub-assembly 43 are configured and cooperatively positioned to provide a labyrinth 80 of relatively small-clearance passages 80a, 80b extending between enclosure 30 and an exterior of the seal assembly, for preventing migration of contaminants from the exterior of the seal assembly into the enclosure. Specifically, positioning of shield member first wall 24a as shown in combination with the tendency of lips 28a-28b to urge slinger-encoder sub-assembly 43 toward shield member 24 produces a relatively small clearance 80a between encoder 40 and shield member first wall 24a. Similarly, positioning of shield member second wall 24b abutting seal member base portion second wall 26b radially inwardly of the seal member second wall provides a relatively small clearance 80b between a radially outward edge 42c of slinger 42 and shield member second wall 24b. The narrowness of passages 80a and 80b restricts the entry of contaminants into the passages, and also restricts the flow of contaminants along the passages.

In addition, a well 80c is formed between slinger 42, encoder 40, and shield member walls 24a and 24b. It is believed that any contaminants migrating along passage 80a will tend to stall or stop within well 80c, tending to reside in or become trapped in the well. Thus, well 80c becomes an obstruction to the flow of contaminants along labyrinth 80, substantially preventing migration of the contaminants from passage 80a to passage 80b. Furthermore, passages 80a and 80b extend in different directions, with passage 80b in FIG. 3 extending substantially orthogonally to passage 80a. Thus, forces tending to urge contaminants along passage 80a may not tend to urge contaminants along passage 80b. In this way, the diversity in passage direction provided by labyrinth 80 acts to impede flow of contaminants from the exterior of the seal assembly into enclosure 30, and labyrinth 80 enhances the sealing function of seal assembly 20.

The cassette seal assembly disclosed herein provides several advantages over previous bearing seals. Abutting engagement of shield member 24 and seal member 22 provides an enclosure within which a target ring or other element of a sensor assembly may be positioned and secured. This engagement also enhances the seal formed by engagement between resilient portions 28a, 28b and slinger 42. This engagement also maintains the target ring/slinger sub-assembly 43 within enclosure 30 during handling of the cassette seal assembly and assembly of the seal assembly onto the wheel bearing. Furthermore, the substantially rectangular cross-sectional shape of the cassette seal assembly enables multiple cassette assemblies to be stacked for efficient assembly into associated wheel bearings without adjacent cassette assemblies adhering to each other through magnetic attraction, and without interference between physical features of the adjacent cassette assemblies. Also, the structure of the cassette assembly and use of the assembly tool described herein to assemble the cassette into the wheel bearing aid in providing a controllable and consistent spacing between the target wheel and an end surface 12a of the wheel bearing, thereby providing greater control of the air gap between the sensor and the sensed element incorporated within the cassette seal.

It will be understood that the foregoing description of the present invention is for illustrative purposes only, and that the various structural and operational features herein disclosed are susceptible to a number of modifications, none of which departs from the spirit and scope of the present invention. The preceding description, therefore, is not meant to limit the scope of the invention. Rather, the scope of the invention is to be determined only by the appended claims and their equivalents.

1. A seal assembly for receiving at least a portion of an element of a sensor system therein, comprising:
an annular seal member; and
an annular shield member abutting the seal member.

2. The seal assembly of claim 1 wherein the shield member is affixed to the seal member.

3. The seal assembly of claim 2 wherein the shield member and the seal member form a monolithic structure.

4. The seal assembly of claim 1 wherein an interference fit is formed between the shield member and the seal member.

5. The seal assembly of claim 1 wherein the seal member comprises a base portion and at least one resilient portion extending from the base portion to resiliently engage another portion of the seal assembly, thereby forming a seal.

6. The seal assembly of claim 5 wherein the seal member includes a plurality of resilient portions extending from the base portion to resiliently engage the other portion of the seal assembly.

7. The seal assembly of claim 1 wherein the seal member and the shield member define an enclosure for receiving the at least a portion of the element of the sensor system therein.

8. The seal assembly of claim 7 further comprising at least a portion of an element of a sensor system positioned within the enclosure.

9. The seal assembly of claim 8 wherein the element of the sensor system comprises a target ring.

10. The seal assembly of claim 9 wherein the target ring includes a magnetic encoder incorporated therein.

11. The seal assembly of claim 1 wherein a cross-section of the seal assembly is substantially rectangular in shape.

12. The seal assembly of claim 1 further comprising at least one resilient portion extending from the base portion for engaging a portion of a second seal assembly.

13. A cassette sensor system element assembly comprising:
an annular seal member;
an annular shield member abutting the seal member to define an enclosure for receiving and maintaining at least a portion of a sensor system element therein; and
a sensor system element having at least a portion thereof secured within the enclosure.

14. The cassette sensor system element assembly of claim 13 wherein the sensor system element comprises a target ring for use in a wheel speed sensor system.

15. The cassette sensor system element assembly of claim 13 wherein a portion of the seal member engages a portion of the sensor system element to form a seal.

16. The cassette sensor system element assembly of claim 13 further comprising a plurality of passages extending between the enclosure and an exterior of the enclosure, the passages being dimensioned so as to substantially prevent a flow of contaminants from the exterior of the enclosure into the enclosure.

17. The cassette sensor system element assembly of claim 16 wherein a passage of the plurality of passages extends between the shield member and the sensor system element.

18. The cassette sensor system element assembly of claim 16 wherein a passage of the plurality of passages extends between the sensor system element and the seal member.

19. The cassette sensor system element assembly of claim 16 wherein a first passage of the plurality of passages extends in a first direction, a second passage of the plurality of passages extends in a second direction, and wherein the first direction is different from the second direction.

20. The cassette sensor system element assembly of claim 16 further comprising a well positioned between a first passage of the plurality of passages and a second passage of the plurality of passages, for trapping contaminants migrating between the first and second passages.
